(19) United States
(12) Patent Application Publication
(10) Pub. No.: US 2008/0147526 A1
(43) Pub. Date: Jun. 19, 2008

(54) Computer-Facilitated Account-Transaction System and Method with Multi-Entity Control Logic

(76) Inventors: Gene Allen, Vadnais Heights, MN (US); Kevin Kuntz, South St. Paul, MN (US)

Correspondence Address: CRAWFORD MAUNU PLLC, 1150 NORTHLAND DRIVE, SUITE 100, ST. PAUL, MN, 55120, US

(21) Appl. No.: 11/956,783

(22) Filed: Dec. 14, 2007

Related U.S. Application Data
(60) Provisional application No. 60/875,208, filed on Dec. 15, 2006.

(51) Int. Cl. G06Q 30/00

(52) U.S. Cl. 705/30

(57) ABSTRACT

Systems and methods for use with accounts held at financial institutions and educational institutions are implemented according to a variety of embodiments. According to one such embodiment, a computer-facilitated system is implemented for use with a first set of accounts held at a financial institution and a second set of accounts held at an educational institution. The accounts are associated with a common set of users and a set of user articles containing user identification information for the set of users. An account setup interface receives user data to establish a first account in the first set of accounts and a second account in the second set of accounts. Control logic stores account information and access rules in respective databases. The account information includes an association between the first and second accounts. An account access interface provides access to the accounts in response to user articles or access codes.

### RELATED PATENT DOCUMENTS

This patent document claims the benefit, under 35 U.S.C. § 119(e), of U.S. Provisional Patent Application No. 60/875,208 filed on Dec. 15, 2006 and entitled: “Computer-Facilitated Account-Transaction System and Method with Multi-Entity Control Logic,” which is fully incorporated herein by reference.

### FIELD OF THE INVENTION

The present invention relates to a computer-facilitated system and method for reconciling, tracking and/or managing transactions, in response to a user article, between a financial institution and an educational institution. In a particular embodiment, the invention is directed to such operation in connection with transactions relative to an account held at a banking institution and relative to a student transaction account at an educational institution.

### BACKGROUND

Financial institutions provide account services to account holders using a variety of interfaces, such as web interfaces, tellers and automated teller machines (ATMs). These interfaces allow for multiple access points and otherwise facilitate access to account held by the account holders. Similarly, educational institutions provide account services to students, faculty, staff, alumni or others with an appropriate relationship with the university. The accounts can be typically accessed through web interfaces or through computers (e.g., specialized computer kiosks) provided by the educational institution. Such computers require an investment in initial funding and maintenance costs by the educational institution.

Users often have the desire to have their account(s) held at both a financial institution and an educational institution and also desire to move funds from one account to the other. Such transfers can be difficult to effect because the individual typically needs to access the accounts separately and use some mechanism to transfer the funds between the accounts. For instance, some educational institutions allow for funds to be deposited in an account through checks, credit cards and cash deposits. Such methods often require the individual to access both accounts individually (e.g., to withdraw cash for depositing in another account) or to deal directly with a person who accepts the transfer of funds. Directly dealing with a person often limits the account holder to normal business hours and can cost the institution funds because the institution pays for the employees to process the account transfers.

Students make up a large portion of an educational institution's population. Often students are younger and from remote locations, and thus, may not have existing accounts at local financial institutions or, for that matter, with any financial institution. Moreover, many students have close financial relationships with their parents or guardians, such as receiving payments to support their educational expenses. While a student may wish to allow deposits to their account from a parent or guardian, the parent or guardian may desire to have some monitoring of the deposited funds and desire that the student not have access to the guardian's personal accounts. Thus, it can be difficult to enroll and otherwise manage accounts held at educational and financial institutions.

These and other issues have presented challenges to the implementation of accounts held by users at financial and educational institutions.

### BRIEF DESCRIPTION OF THE DRAWINGS

The invention may be more completely understood in consideration of the detailed description of various embodiments of the invention that follows in connection with the accompanying drawings, in which:

FIG. 1 is a block diagram showing a system for handling of accounts held at a financial institution system and an educational institution system, according to an example embodiment of the present invention;

FIG. 2 is a block diagram showing information flow between a financial institution system and an educational institution system, according to an example embodiment of the present invention;

FIG. 3 is a flow diagram showing exemplary steps for implementing financial transactions between accounts, according to an example embodiment of the present invention; and

FIG. 4 is a diagram depicting an account transaction system including automated teller machines and identification cards, according to an example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

In various embodiments, the present invention relates to a computer-facilitated system and method for managing accounts associated with a financial institution and an educational institution.

Consistent with one embodiment of the present invention, a computer-facilitated system is implemented for monetary accounts held by individuals at educational institutions and at financial institutions. The system allows an educational or financial institution to create accounts for the individuals. The step of creating an account includes storing account information in a database. The system can also link accounts held at both institutions by the same individual. An individual can access their accounts using a remote interface, such as an automated teller machine (ATM) or remote computer via a network interface.

Consistent with another embodiment of the present invention, access through a remote interface is accomplished using authentication measures. The individual may be required to swipe an identification card at an ATM or to provide a username and password. In some instances, more than one individual can be associated with an account. In one such instance, a parent or guardian can be allowed to deposit money, view account balances and track spending from the accounts of their dependent. The dependent (e.g., student) would also be allowed to deposit money, view account balances and track spending. In addition, the dependent can perform functions, such as withdrawing cash, retail purchases and similar debit type transactions. The system may also access different accounts for different types of transactions or for transactions involving different entities. In one example, the system debits the account held at the educational institution when used for educational related transactions, while debiting the account held at the financial institution when used for other transactions.

One aspect of the present invention is directed to arrangements and methods for facilitating transactions between an account held at a financial institution and an account held at an educational institution. For example, a user is assisted in transferring value from the financial institution account to the educational institution account. The accounts can be accessed by a user through a number of different channels, including automated teller machines (ATMs), Internet transactions, bank teller transactions, and voice response systems (e.g., phone system). As used herein, an ATM is a special-purpose transaction terminal used to provide remote banking services. Such terminals provide limited functionality, including accessing account information and potentially allowing a user to effect transfers between accounts. Moreover, a number of regulations, federal or otherwise, govern the use of ATMs, such as the Electronic Funds Transfer Act (EFTA).

Another aspect of the present invention is directed to verification of transactions between the financial institution and the educational institution. The verification can be accomplished in one or more stages. For example, the educational institution can provide an immediate response verifying that a transaction request has been received. In another stage, the educational institution periodically provides the financial institution with a file of all transactions that have been processed. The financial institution compares the received file with a database containing a record of transactions requests sent to the educational institution.

In one embodiment of the present invention, users access an interface linked to a financial institution system and request transfers from accounts held at the financial institution to accounts held at an educational institution. The financial institution system processes the requests, issues transaction requests to the educational institution and stores a record of the transactions. The educational institution receives the requests and credits an account held at the educational institution. The educational institution stores a record of completed transactions. Periodically, or upon a request from the financial institution, the educational institution creates a transaction file containing the stored record of completed transactions. The transaction file is sent to the financial institution where it is verified against the financial institution's stored record of financial transactions. In this manner, the transfer of funds from one account to the other can be facilitated.

In a particular embodiment of the present invention, the users access the interface using a card that identifies both accounts. For example, the card may be a student identification card issued by the educational institution. In one such instance, the card can be used in connection with both card readers used by the educational institution and ATMs used by the financial institution.

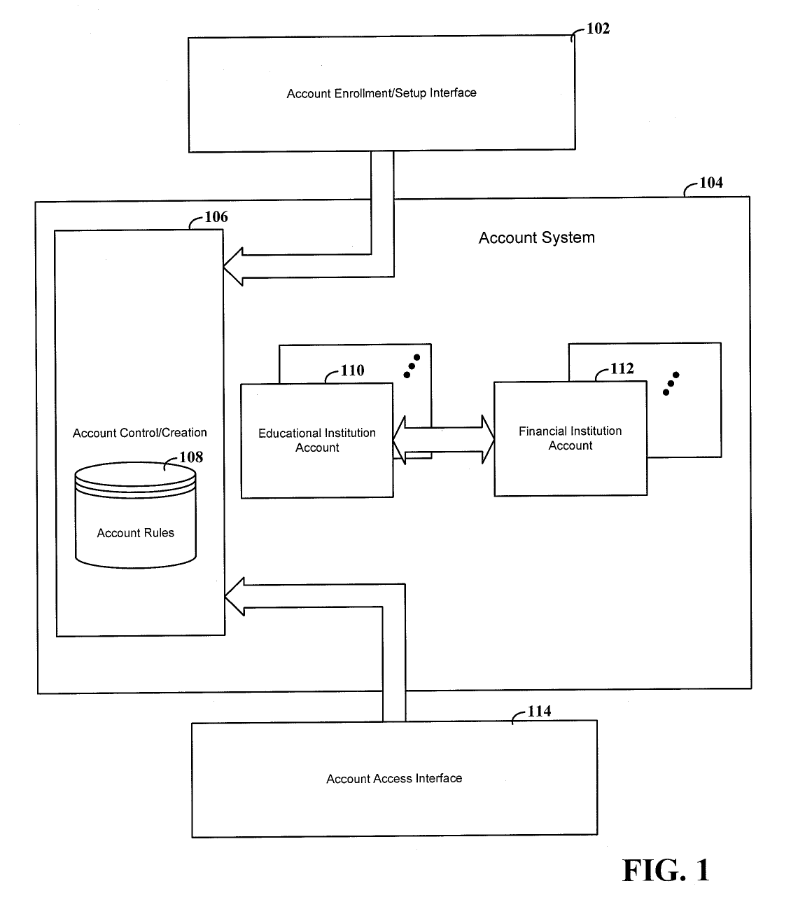

Turning now to the figures, FIG. 1 shows a system for creating and controlling accounts held at educational and financial institutions. Account related data is sent to and from account system 104 through interfaces 102 and 114.

Account enrollment/setup interface 102 allows users of the system to input information necessary to create new accounts (i.e., educational institution accounts 110 and financial institution accounts 112). One type of information includes an indication of the institutions for which the student wishes to create an account. In a specific example, a student new to an educational institution provides identification information (e.g., name, address, citizenship, social security number and driver's license number) as required by the institutions as well as by regulator laws. Additional information can also be entered, such as preexisting accounts held at various financial institutions by the student or the student's guardian, amount of initial deposit, requested username and password for remote access and other account-related information.

This information is sent to account control/creation block 106. Block 106 processes the information in order to facilitate the creation of the appropriate accounts. This can be accomplished a number of ways. In one instance, block 106 has account creation rights to stores the appropriate account information in a database for the particular institution the account is held at. In such an instance, block 106 would perform the steps necessary to verify the account information. This is particularly useful for fast account setup and for reducing the processing required to establish new accounts. In another instance, block 106 can forward an account creation request to the appropriate institution's account system. The institution's account system can then process the creation request after verifying, for example, that the appropriate information has been received. This can be particularly useful for allowing the institutions to control the account creation criteria and safeguards. Variations of these models can be implemented, including block 106 having account creation rights to one or more institutions, while not having creation rights to one or more other institutions. This can be particularly useful for implementations where interface 102 is remotely located, controlled or monitored by only some of the institutions, as the institutions that do not control or monitor interface 102 can have their own level of verification.

In one embodiment of the present invention, interface 102 includes a plurality of interfaces. Thus, the educational or financial institution may each have several interfaces for account setup, or the educational and financial institution may each have one interface for setup. In another instance, a third party may provide one or more setup interfaces. Similarly, block 106 can be implemented as a plurality of control arrangements that can be controlled by various parties. In a particular instance, the interface used determines the account creation rights provided. Thus, a setup interface provided by an educational institution may have account creation rights at the educational institution, but not at a financial institution. Likewise, a setup interface provided by a financial institution may have account creation rights at the financial institution, but not the educational institution. In another instance, the particular control block used determines the account creation rights provided.

Block 106 can make a determination as to the course of action based upon account rules database 108. In one instance, account rules database determines the required account information for particular situations. An account creation request for an educational account may require different information than a request for the creation of a financial account. Similarly, an account creation request for both an educational and a financial account may require different information than either account request alone. Other factors that may affect the content of the required information include, but are not limited to, citizenship, access requests for additional individuals, particular account options desired and whether the account holder is a minor. For instance, it may be desirable to set up the account with the parent or guardian as the primary account holder for both accounts. The minor can then be given limited access to one or more of the accounts. This is particularly useful for controlling and monitoring the expenditures of a minor.

Account access interface 114 allows users of system 104 to access existing accounts 110 and 112. Access can include such tasks as viewing account details, requesting monetary transfers, changing account holder address, withdrawing cash, depositing money and the like. Interface 114 can be implemented using a number of different arrangements and methods including ATMs, websites and kiosks.

Often, some form of security is required to protect the information sent between interface 114 and system 104. Thus, the data can be encrypted using various methods and devices, the details of which have been omitted for the sake of brevity. Another level of security includes the use of a user article that contains account information. One such user article is a card with a magnetic strip, integrated chip or similar identification device. Other security methods involve passwords and biometric security devices (e.g., facial recognition and fingerprints). In addition to verifying an individual's identity, these security measures can also be used to identify the accounts associated with the individual as well as the access rights to those accounts. The particular access rights can be stored in account rules database 108. These rules can be based on a number of factors, including the identity of the individual requesting access, the type and number of accounts to be accessed, the interface being used to access the account and the like.

In one embodiment, a user article can be used by an account holder to make purchases. These purchases can be debited to accounts 110 and 112 depending upon the particular situation. In one instance, the educational account can be debited for educational and related purposes. Such purposes can include, for example, all purchases that are credited to the educational institution, its affiliates and to a network of retailers. The financial account 112 can be debited for other transactions, such as standard debit card uses (e.g., in store purchases and online purchases). In another instance, the user is presented with the option of selecting the account to be debited. This selection option can be presented at the time of purchase, or alternatively, can be pre-selected by the user and stored in rules database 108. For instance, the user can select that cafeteria purchases at the educational institute are to be debited from the educational institution account, while other purchases are to be debited from the financial institution account. In another instance, a parent or guardian may wish to limit the uses of an account and can set the limitations accordingly.

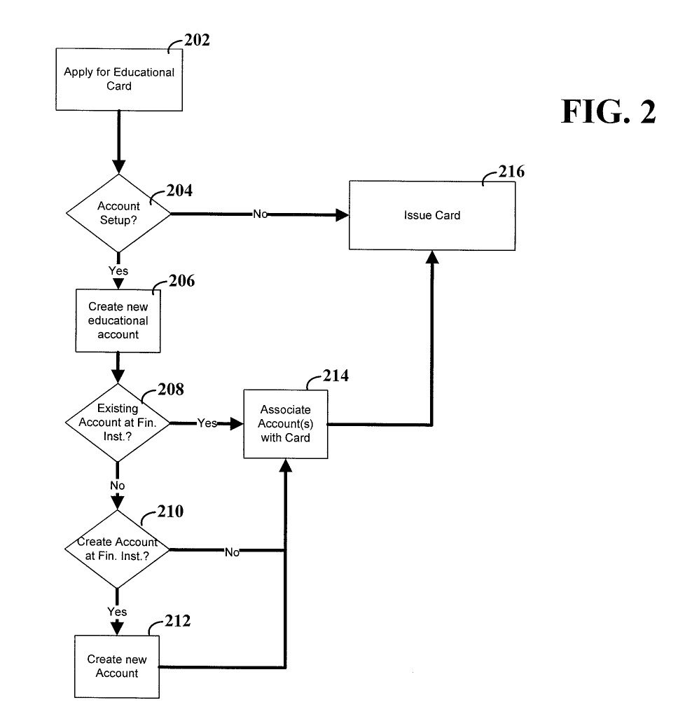

FIG. 2 is logical flow diagram of an example process for account setup, according to an example embodiment of the present invention. The flow diagram begins with an application for an educational card as shown by block 202 and concludes with the card being issued as shown by block 216. A new student, faculty member, employee or the like applies for an identification card at block 202. Identification cards are widely used by many educational institutions to show association to the particular institution, and thus, the process of applying for an identification card is a current requirement for many new students and faculty. Accordingly, the issuance of a card is often an expected cost to the educational institution, and thus, might be considered a negligible step in terms of costs to the institutions. Block 204 is a determination step as to whether to create a monetary account for the applicant. This can be determined based upon a number of factors, such as account policies, selection by the applicant or a combination thereof. If it is determined that no account is to be created, the process proceeds to block 216. Otherwise, the process proceeds to block 206.

At block 206, a new educational account is created for the applicant. As discussed herein, this can occur immediately or in response to an account creation request sent to the appropriate institution. The process next proceeds to decision block 208 where it is determined whether the applicant has an existing financial account that is desired to be linked to the educational account. If it is determined that there is such an existing account, the process proceeds to block 214 where both accounts are associated with the identification card. The process then advances to block 216, where the card is issued to the applicant. If it is determined that there is no such existing account, the process proceeds to block 210 where it is determined whether a new financial institution account is to be created.

The determination of block 210 can be based upon a number of factors, such as account policies, selection by the applicant or combination thereof. If it is determined that no new account is to be created, the process proceeds to block 214 with only the educational account being associated with the card. If it is determined that a new account is to be created, the process proceeds to block 212 where a new financial institution account is created. The process then proceeds to block 214, where the accounts are each associated with the card.

The particulars of associating the card with the account(s) can take a number of different forms. In one instance, the card stores identification data, such as a university identification number. This number can be stored in a database of account information, thereby linking the associated accounts to the identification data. In another instance, the card stores account information, such as the account numbers. Other variations are contemplated that allow the accounts associated with the card to be identified based on different types of information stored by the card (e.g., user identification number).

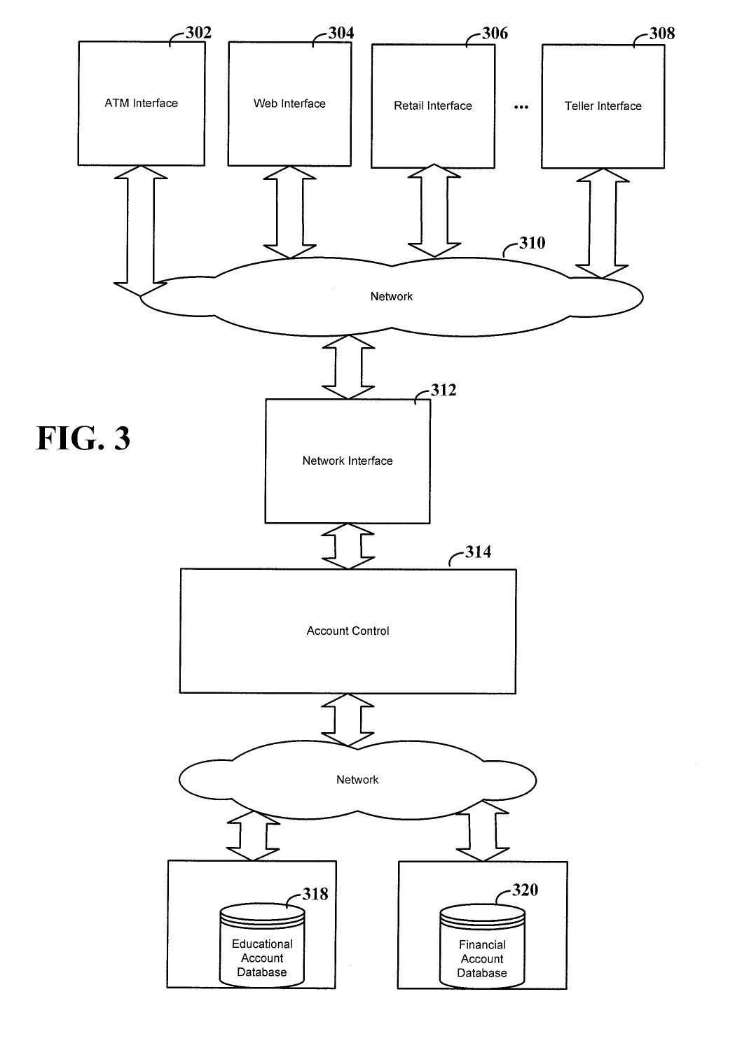

FIG. 3 shows a block diagram of an account transaction system having multiple user interfaces, according to an example embodiment of the present invention. ATM interface 302, web interface 304, retail interface 306 and teller interface 308 are each examples of interfaces that allow access to educational account database 318 and financial account database 320. These interfaces are shown as connecting to network 310. In a particular embodiment of the present invention, network 310 is a packet-based network, such as the Internet. In another embodiment of the present invention, network 310 can be any number of different data communication networks. For instance, an ATM network may transmit data using a different network from a web interface. Similarly, a teller interface may transmit data using a local area network (LAN).

Network interface 312 provides an appropriate connection to network 310 (e.g., Ethernet, fiber optic and wireless devices). In one instance, network interface 312 can appear as a single access node. In another instance, network interface 312 provides numerous connection points, each potentially using a different protocol and data transport medium. Data received by network interface 312 is subsequently passed to account control block 314.

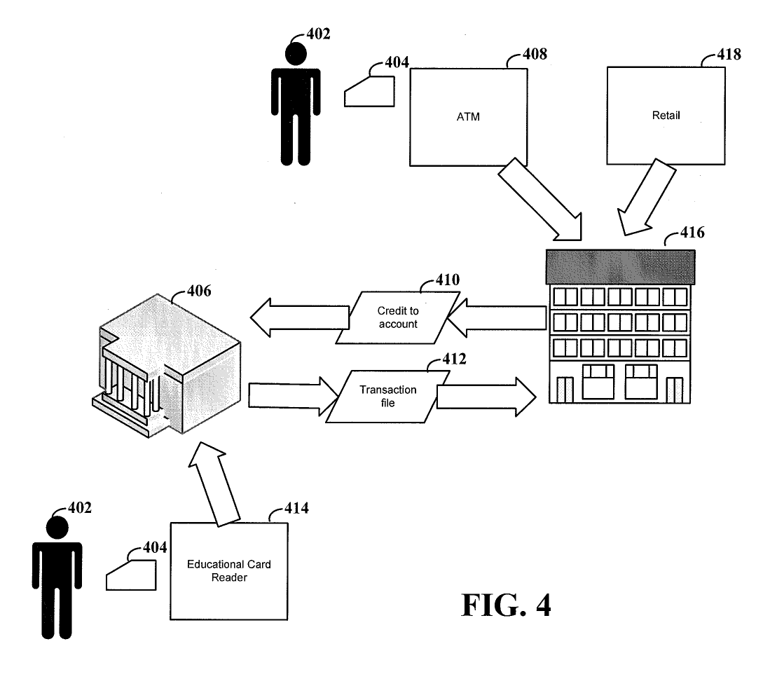

FIG. 4 is a diagram depicting an account transaction system including ATMs and ID cards, according to an example embodiment of the present invention. User 402 is provided with ID card 404, which can be used in both card reader 414 and ATM 408. The card represents (or ostensibly authenticates) user 402 and also provides account information to card reader 414 and ATM 408. Additional security measures can be implemented, such as requiring that user 402 provide a password or pin number.

User 402 uses card 404 at card reader 414 to make purchases from an account held at education institution 406. The purchases are credited from the account to the educational institution selling the goods or services. In this manner, different educational institution-related departments and associations (e.g., athletic department, computer technology department, tuition department and educationally-sponsored clubs/associations) can be credited from value in the account for expenses paid for by user 402.

In order to facilitate the addition of funds to the educational account from an account held at financial institution 416, ATM 408 accepts card 404. ATM 408 can be configured to recognize that card 404 is linked to both a financial institution account and an education institution account and in response offers user 402 with an option to transfer funds between the accounts. If a user of ATM 408 is accessed by users who do not have educational accounts, ATM 408 does not provide the users with the transfer funds option. If user 402 chooses the transfer funds option, ATM 408 forwards a transfer request corresponding to an amount selected by user 402. Financial institution 416 sends a request 410 to credit the educational account to education institution 406. Financial institution 416 also debits the financial account and keeps a record of the transaction. Educational institution 406 receives request 410 and credits the education account so that user 402 can access the transferred funds using campus reader 414. Periodically, education institution 406 prepares a transaction file 412 of all newly received requests and provides the file to financial institution 416 where it is verified. Upon verification, financial institution 416 can finalize the transactions and provide any necessary settlement to education institution 406.

In order to facilitate the retail purchases using the card 404, retail interface 418 provides another access point for user 402. Retail interface 418 can be used to enact in-store purchases, internet sales or the like. The interface can be configured to send information on card 404 to a predetermined account. For instance, the transaction system can be configured to treat all purchases as debits from the financial institution account unless they are related to the educational institution. Thus users with accounts held both the educational institution and the financial institution can access their accounts and make purchases using a single card. In one implementation, card 404 is an identification card containing a picture of user 402. Identification cards are currently issued by many educational institutions, and thus, would not necessarily require additional effort and/or cost to issue the card 404 with a picture of user 402. This can be useful for providing additional security in case of the loss or theft of card 404.

The various embodiments described above and shown in the figures are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For instance, applications other than the student identification cards may be amenable to implementation using multiple software and computer hardware devices. In addition, one or more of the above example embodiments and implementations may be implemented with a variety of approaches, including various Internet based approaches. Further, the skilled artisan would appreciate that the above-discussed interfaces and depicted modules and blocks can be implemented in a variety of manners including, for example, as a CPU node communicatively-coupled via a public or private network. These approaches are implemented in connection with various example embodiments of the present invention. Such modifications and changes do not depart from the true scope of the invention.

What is claimed is:

1. A computer-facilitated system for use with a first set of accounts held at a financial institution and a second set of accounts held at an educational institution, the first and second sets of accounts being associated with a set of users common between the first and second sets of accounts and with a set of user articles containing user identification information for the set of users, the system including:
an account setup interface that receives user data to establish a first account in the first set of accounts and a second account in the second set of accounts;
control logic that stores account information in respective databases for the first and second accounts and that stores access rules for the first and second accounts in a database, wherein the account information includes an association between the first and second accounts; and
an account access interface that provides access to the account information to the set of users in response to at least one of a user article from the set of user articles and an access code.

2. The system of claim 1, wherein access is provided in response to the user article and the user article is an identification card issued by the educational institution for users associated with the educational institution.

3. The system of claim 1, wherein the account access interface provides access using an Internet-based website.

4. The system of claim 1, wherein the first account of the first set of accounts is a savings account or a checking account and the second set of accounts are university debit accounts.

5. The system of claim 2, wherein the account access interface provides access using an automated teller machine in response to determining the user article was issued by the educational institution.

6. The system of claim 1, wherein the account access interface determines whether the account information is being accessed for use by a retailer other than the educational institution and in response to the determination, provides access to an account from one of the first and second sets of accounts.

7. The system of claim 6, wherein if the determination is that the access is for use by said retailer, an account from the first set of accounts is accessed and otherwise an account from the second set of accounts is accessed.

8. The system of claim 1, wherein the set of users includes a first user and a second user, the first and second users having different levels of access to the first and second accounts.

9. The system of claim 8, wherein the first user is a student at the educational institution.

10. A computer-facilitated method for use with a first set of accounts held at a financial institution and a second set of accounts held at an educational institution, the first and second sets of accounts being associated with a set of users common between the first and second sets of accounts and with a set of user articles containing user identification information for the set of users, the method including:
establishing a first account in the first set of accounts and a second account in the second set of accounts in response to a request to create a new account;
storing account information in respective databases for the first and second accounts and access rules for the first and second accounts in a database, wherein the account information includes an association between the first and second accounts; and
providing access to the account information to the set of users in response to at least one of a user article from the set of user articles and an access code.

11. The method of claim 10, wherein access is provided in response to the user article and the user article is an identification card issued by the educational institution for users associated with the educational institution.

12. The method of claim 10, wherein access is provided using an Internet-based website.

13. The method of claim 10, wherein each account of the first set of accounts is a savings account or a checking account and the second set of accounts are university debit accounts.

14. The method of claim 11, wherein access is provided using an automated teller machine in response to determining the user article was issued by the educational institution.

15. The method of claim 10, further including determining whether the account information is being accessed for use by a retailer other than the educational institution and in response to the determination, providing access to an account from one of the first and second sets of accounts.

16. The method of claim 15, wherein if the determination indicates that the access is for use by said retailer, access is provided to an account from the first set of accounts otherwise access is provided to an account from the second set of accounts.

17. The method of claim 10, wherein the set of users includes a first user and a second user, the first and second users having different levels of access to the first and second accounts.

18. The method of claim 10, further comprising:
receiving a funds transfer request from a user of the set of users to transfer an amount of funds from the first account to the second account;
processing the funds transfer request by the financial institution; and
instructing, by the financial institution, the educational institution to credit the second account by the amount of the funds transfer request.

19. The method of claim 10, wherein the educational institution periodically provides the financial institution with a transaction file that contains records of competed transactions associated with the first and second sets of accounts.

20. A computer-facilitated system for use with a first set of accounts held at a financial institution and a second set of accounts held at an educational institution, the first and second sets of accounts being associated with a set of users common between the first and second sets of accounts and with a set of user articles containing user identification information for the set of users, the system including:
means for establishing a first account in the first set of accounts and a second account in the second set of accounts in response to a request to create a new account;
means for storing account information in respective databases for the first and second accounts and access rules for the first and second accounts in a database, wherein the account information includes an association between the first and second accounts; and
means for providing access to the account information to the set of users in response to at least one of a user article from the set of user articles and an access code.
